(19) United States
(12) Patent Application Publication
(10) Pub. No.: US 2016/0242160 A1
(43) Pub. Date: Aug. 18, 2016

(54) WIRELESS COMMUNICATION DEVICE AND METHOD FOR CHOOSING MOST RAPID ACCESS DEVICE

(71) Applicant: HON HAI PRECISION INDUSTRY CO., LTD., New Taipei (TW)

(72) Inventor: PENG-YU LIAO, New Taipei (TW)

(21) Appl. No.: 15/011,636

(22) Filed: Jan. 31, 2016

(30) Foreign Application Priority Data
Feb. 12, 2015 (TW) 104104856

(51) Int. Cl. H04W 72/04; H04B 17/318; H04W 76/02; H04W 48/16; H04L 12/26; H04W 8/24; H04W 24/02

(52) U.S. Cl. CPC H04W 72/0406; H04W 8/245; H04B 17/318; H04W 24/02; H04W 48/16; H04L 43/16; H04W 76/02

(57) ABSTRACT

A wireless communication device has an establishing module, a broadcast module, a calculation module, and a selection module. The establishing module establishes wireless communication device which have the same SSID and security identifier to build all such devices into a wireless network group. The broadcast module broadcasts its own wireless network attributes information to the other wireless communication devices according to network group managing protocol. The calculation module calculates a first transmission period for transmitting the wireless network attributes information from one wireless communication device to each uplink device of each of the other wireless communication devices, and calculates a second transmission period for the client terminal itself to receive the wireless network attributes information. The selection module selects the best access device according to calculations made using the first transmission period and the second transmission period. More than one method for choosing a best device is also presented.

### FIELD

The subject matter herein generally relates to network communication technology.

### BACKGROUND

A client terminal often requires using a wireless network, thus a choice of wireless access device will need to be made. Since the variety of wireless access devices and the mobility of clients is wide, when the client terminal selects a router or a repeater in a wireless network, all the wireless access devices with their different rates will be changing continuously.

### BRIEF DESCRIPTION OF THE DRAWINGS

Implementations of the present technology will now be described, by way of example only, with reference to the attached figures.

FIG. 1 is a diagrammatic view of an operating environment of an embodiment of a wireless communication device.

FIG. 2 is a block diagram of an embodiment of function modules of a wireless communication device.

FIG. 3 is a block diagram of one embodiment of another wireless communication device.

FIG. 4 is a diagrammatic view of an embodiment of relationship matching signal transmission rate and signal strength.

FIG. 5 is a sample figure of an embodiment of a wireless communication device selecting the best access device when the client terminal is roaming.

FIG. 6 is a flowchart of an embodiment of a method for a wireless communication device for selecting the best access device.

FIG. 7 is a flowchart of an embodiment of a method for a wireless communication device calculating the first transmission period.

FIG. 8 is a flowchart of an embodiment of a method for a wireless communication device calculating a second transmission period.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

It should be noted that references to “an” or “one” embodiment in this disclosure are not necessarily to the same embodiment, and such references mean “at least one.”

In general, the word “module” as used hereinafter, refers to logic embodied in computing or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY, flash memory, and hard disk drives. The term “comprising”, when utilized, means “including, but not necessarily limited to”; it specifically indicates open-ended inclusion or membership in a so-described combination, group, series and the like.

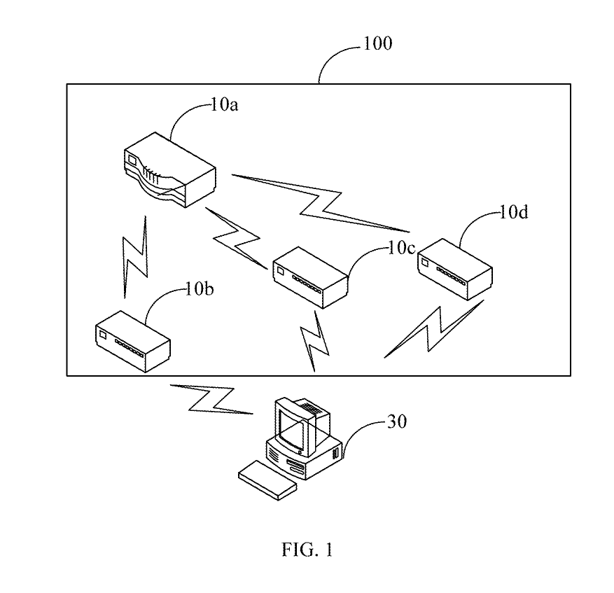

FIG. 1 is a diagrammatic view of an operating environment of embodiments of wireless communication devices 10a-10d. In this embodiment, the wireless communication devices 10a-10d communicate with each other via wireless network. The wireless communication devices 10a-10d are configured as access devices providing wireless network service for a client terminal 30, and these are grouped into a wireless network group (wireless network group 100). The client terminal 30 selects one of the wireless communication devices 10a-10d according to strength of wireless network signal. The wireless communication devices 10a-10d may be, for example, routers and/or gateways. The wireless communication device 10a which is near to the client terminal 30 also may be a repeater, or configured as a repeater.

In this embodiment, the devices 10a-10d establish a wireless network group 100 on the basis that the devices 10a-10d have the same service set identifier (SSID) and security identifier. The client terminal 30 seeks the fastest access device.

After the wireless network group 100 is established, the devices 10a-10d broadcast information to each other, and calculate time for broadcasting information between two devices 10a-10d. Furthermore, the devices 10a-10d broadcast information to the client terminal 30 regarding time for broadcasting information from each device 10a-10d to the client terminal 30. Finally, one of the device 10a-10d which has shortest broadcasting time is selected as an access device connecting to the client device 30, according to calculated time for broadcasting.

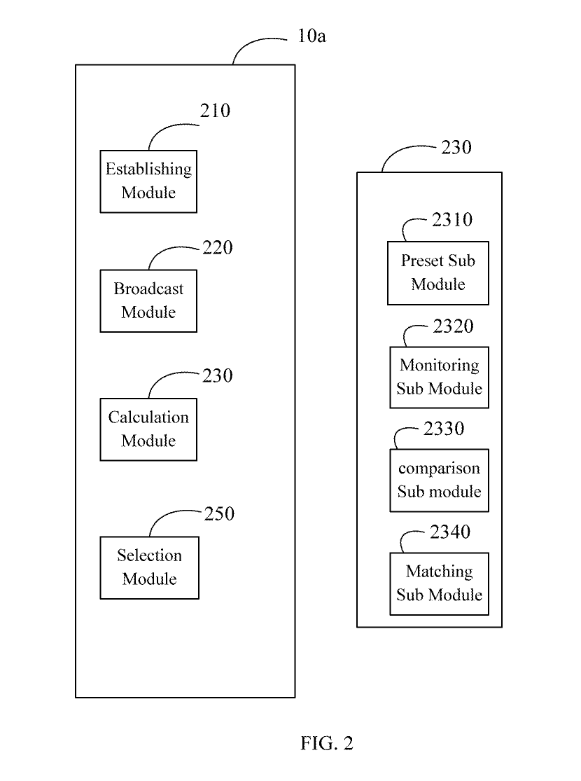

Referring to FIG. 2, an embodiment of function modules of a wireless communication device 10a is shown. In this embodiment, the wireless communication device 10a includes an establishing module 210, a broadcast module 220, a calculation module 230, and a selection module 250.

In the embodiment, the establishing module 210 establishes which of the devices 10a-10d have the same SSID and the security identifier, to be grouped into the wireless network group 100. Two of the devices 10a-10d transmit data according to the pre-defined network group managing protocol (NGMP), wherein the specific NGMP is shown in Table 1.

TABLE 1
NGMP

| Data | Transmis- | |
|---|---|---|
| form | sion mode | Description |
| Advertise | Broadcast | Predetermined to send, to advertise the hardware |
| | | properties, and the existence of a nearby access |
| | | device. |
| Pull | Unicast | To request an access device to connect to the |
| | | wireless device |
| Query | Unicast | After receiving the client's probe request, |
| | | requesting other access devices to monitor the |
| | | client's status |
| Notify | Unicast | To notify other access devices that the client |
| | | terminal has been connected to them |
| LqQuery | Unicast | The client terminal having been connected, |
| | | predetermined to send monitored state of the |
| | | client terminal to the other access devices |
| Change | Unicast | To determine that the client terminal that has |
| | | been connected should connect to other access |
| | | devices. |

From the Table 1, the NGMP includes information form, transmission mode, and a corresponding description. Each of the devices 10a-10d can be called an access device. Specifically, transmission mode includes broadcasting and unicasting, data form includes advertising, pulling, querying, notifying, and changing. Different data forms correspond to different descriptions. In general, in the wireless group network, the access device regularly broadcasts own hardware attributes to other access device in the vicinity to indicate its existence and its attributes. When an access device is connected with the client terminal, other access devices are informed that the client terminal has connected to that access device itself, and data as to the monitored state of the client terminal is sent to the other access devices regularly. When a request from the client terminal is received, an access device firstly queries monitored state of the client terminal from the other access devices. When the access device needs to be changed, the change information is broadcast to permit their own client to connect to other access devices.

When the wireless communication device 10a is in the wireless network group 100, the broadcast module 220 broadcasts its own wireless network attributes information to the other devices 10b-10d according to NGMP. Furthermore, the broadcast module 220 will broadcast its own wireless network attributes information to the client terminal 30. In other words, the wireless communication device 10a in the wireless network group broadcasts its own wireless network attributes information to the other devices 10b-10d which are nearer, to obtain the wireless network attributes information between the wireless network and the other devices 10b-10d, and the monitored status of the client terminal 30. The wireless network attributes information includes the SSID, the security identifier, and stream number.

After broadcasting information, the calculation module 230 calculates the transmission period for transmitting the wireless network attributes information from the wireless communication device 10a to each of the uplink devices of the devices 10b-10d. This transmission period is called the first transmission period. Furthermore, the calculation module 230 calculates the transmission period for transmitting the wireless network attributes information from device 10a to the client terminal 30, and this transmission period is called the second transmission period. In this way, each of the devices 10a-10d knows the transmission period from itself to each uplink device in the devices 10a-10d, and the transmission period from the most downlink device of the wireless communication device 10b to the most uplink device of the wireless communication device 10a can be calculated (wherein the most downlink device of the wireless communication device is the device which is the furthest from the device 10a, and the most uplink device of the wireless communication device is the device which is the nearest from the device 10a, and the most downlink device and the most uplink device are the uplink devices of the device 10a). Wherein the most uplink device of the wireless communication device 10a may be, for example, gateways or/and routers, and the most downlink device of the wireless communication device 10b may be a repeater, or configured as a repeater, which has the shortest distance from the client terminal 30.

For example, the wireless network group 100 may have two of the devices 10a-10d, namely 10a and 10b. The uplink device of the wireless communication device 10a is a gateway, and the downlink device of the wireless communication device 10b is a repeater. The first transmission period calculated by the calculation module is the time for transmitting information from the gateway to the repeater, and the second transmission period is the time for transmitting the information from the repeater to the client terminal 30.

Then, the selection module 250 selects one of the devices 10a-10d in response to the request of the client terminal 30, and selects the device 10b for the client terminal according to the sum of the first transmission period and the second transmission period being the smallest total.

In the embodiment, the calculation module 230 calculates the first transmission period according to first circulation transmission period and first circulation signal transmission rate, wherein the first transmission period equals the first circulation transmission period divided by the first circulation signal transmission rate. The first circulation transmission period is a round-trip transmission period for transmitting the information between device 10a and one of the uplink devices of the other devices 10b-10d; the first circulation signal transmission rate is a single signal transmission rate multiplied by the stream number, and the single signal transmission rate is a signal transmission rate of the device 10a transmitting wireless network attributes information to the uplink device of one of the other devices 10b-10d.

In the embodiment, the calculation module 230 calculates the second transmission period according to second circulation transmission period and second circulation signal transmission rate, wherein the second transmission period equals the second circulation transmission period divided by the second circulation signal transmission rate. The second circulation transmission period is a round-trip transmission period for transmitting the wireless network attributes information from the device 10a to the client terminal 30.

The calculation module 230 detects and monitors received signal strength indication (RSSI) value of the client terminal 30, and calculates a second signal transmission rate according to the relationship between the detected RSSI value and the second signal transmission rate.

In the embodiment, the calculation module 230 comprises a plurality of sub-modules, and, of the sub-modules, a preset sub module 2310, a monitoring sub module 2320, a comparison sub module 2330, and a matching sub module 2340 calculate the relationship between the detected RSSI value and the second signal transmission rate.

The preset sub module 2310 establishes first relationship between the default RSSI value of the client terminal 30 and index values of a Modulation Coding Scheme (MCS).

The monitoring sub module 2320 monitors the RSSI value and the corresponding signal transmission rate of the client terminal 30 in a predetermined period after the client terminal 30 connects to the wireless communication device 10a. A plurality of values of signal transmission rate are obtained in the condition of a single RSSI value, and an average value of the plurality of values of signal transmission rates is calculated, and an index value in the MCS corresponding to that average value is found, to obtain second relationship between the RSSI values and the index values.

The wireless communication device 10a cannot get the signal transmission rate related to the client terminal 30 if the client terminal 30 is not connected with the wireless communication device 10a. Other signal parameters that relate to such a disconnected client terminal 30 must be found to obtain the signal transmission rate.

The comparative sub module 2330 compares the first relationship with the second relationship according to the index value to obtain a larger RSSI value, and makes adjustments based on the best relationship between the larger RSSI value and the index value.

The matching sub module 2340 obtains such best relationship between the detected RSSI values and the second signal transmission rates.

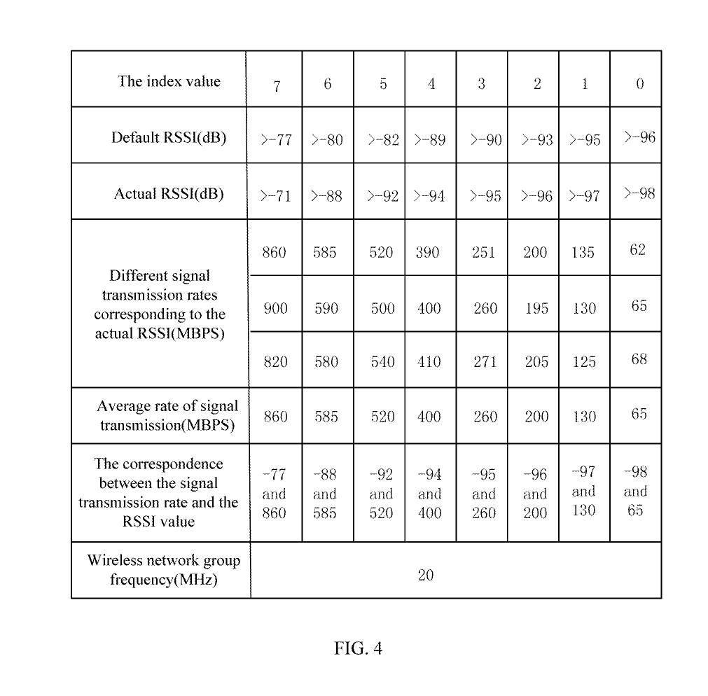

In this way, the signal transmission rate can be obtained by monitoring and calculating the RSSI value of the client terminal 30, FIG. 4 shows a specific example.

FIG. 4 shows a relationship reflecting signal transmission rates matching an RSSI value. In this instance, the index value represents the index value 0 to 7 of the MCS. Different values of the index correspond to different RSSI values and actual RSSI values. FIG. 4 lists three different signal transmission rates, and calculates the average value of the signal transmission rates. The average value corresponds to the actual RSSI value, thus a matching relationship between the rates of the signal transmission and the RSSI value can be found. For matching purposes, the measurements and calculations must be within the network environment of one wireless network group 100. Referring to FIG. 4, the measurements are carried out at the 20 MHz frequency. Other conditions are appropriate to the measurements and calculations.

FIG. 2 shows a client terminal 2 in a roaming state, in an embodiment. When the client terminal 30 is in a roaming state and it detects a new best access device connected to the client terminal 30, the calculation module 230 detects and monitors an RSSI value of the client terminal 30 in the new better access mode and a default RSSI value of the client device terminal in the original best access device, and calculates difference between the default RSSI value and the detected RSSI value.

The selection module 25 configures the client terminal 30 to maintain a connection with the original best access device when the difference is less than a threshold value. The selection module 25 configures the client terminal 30 to connect to the new best access device when the difference is not less than the threshold value.

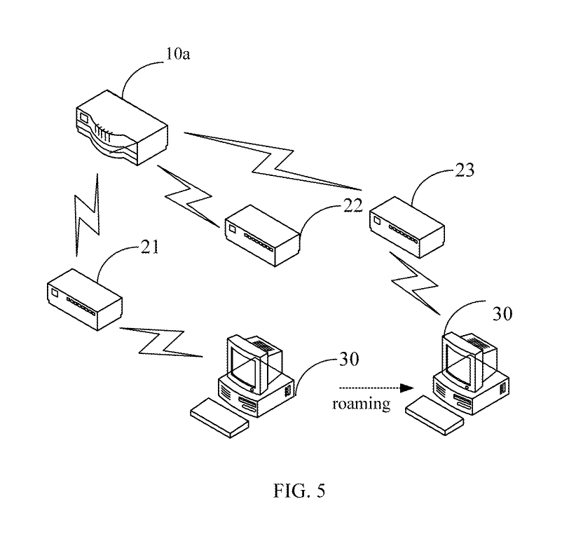

FIG. 5 shows an embodiment of a wireless communication device selecting the best access device when the client terminal is roaming. In this embodiment, the wireless communication device 10a also comprises a specific repeater a 21, a repeater b 22, and a repeater c 23. When the client terminal 30 is roaming, the best pre-roaming access device was repeater a 21. After the client terminal 30 begins roaming, wireless communication device 10a selects the best access device as being repeater c 23. The calculation module 230 monitors the receiver signal strength of the client terminal 30 between the repeater a 21 and the repeater c 23, and calculates any difference in the RSSI value between the repeater a 21 and the repeater c 23. When such difference between the repeater a 21 and the repeater c 23 is less than the threshold value, the selection module 250 selects repeater a 21 to connect to the client terminal 30. When such difference between the repeater a 21 and the repeater c 23 is not less than the threshold value, the selection module 250 selects the repeater c 23 to connect to the client terminal 30.

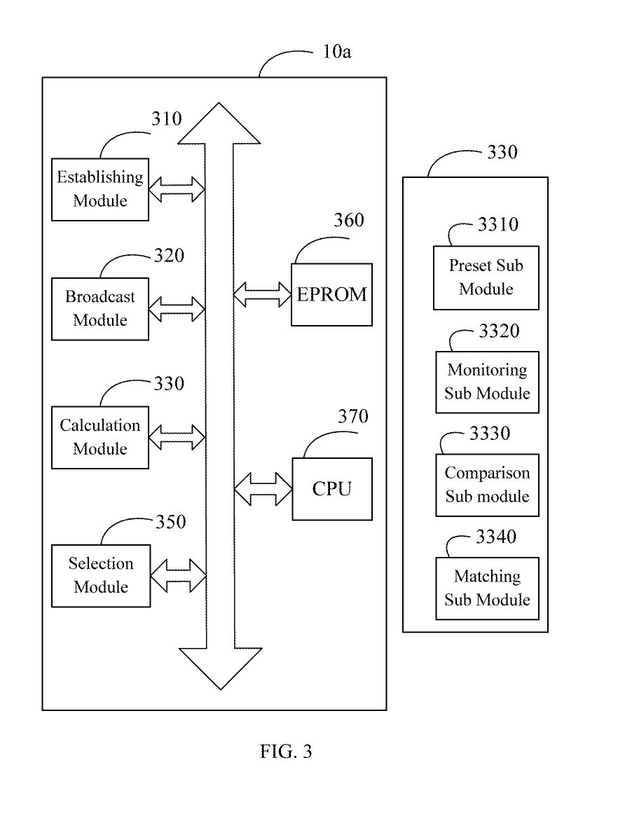

FIG. 3 shows an embodiment of another wireless communication device. In this embodiment, the wireless communication device 12 comprises an establishing module 310, a broadcast module 320, a calculation module 330, a selection module 350, an EPROM module 360, and a CPU module 370. The establishing module 310, the broadcast module 320, the calculation module 330, and the selection module 350 include software program, and the software program is stored in the EPROM module 360. The function of each module is realized through the processor 370. The establishing module 310, the broadcast module 320, the calculation module 330, the matching module 340, and the selection module 350 are respectively the same as the establishing module 210, the broadcast module 220, the calculation module of 230, the matching module 240, and the selection module 250 of FIG. 2.

In an embodiment, the calculation module 330 includes a preset sub module 3310, a monitoring sub module 3320, a comparison sub module 3330, and a matching sub module 3340. The preset sub module 3310, the monitoring sub module 3320, the comparison sub module 3330, and the matching sub module 3340 are respectively the same as the preset sub module 2310, the monitoring sub module 2320, the comparison sub module 2330, and the matching sub module 2340 of FIG. 2.

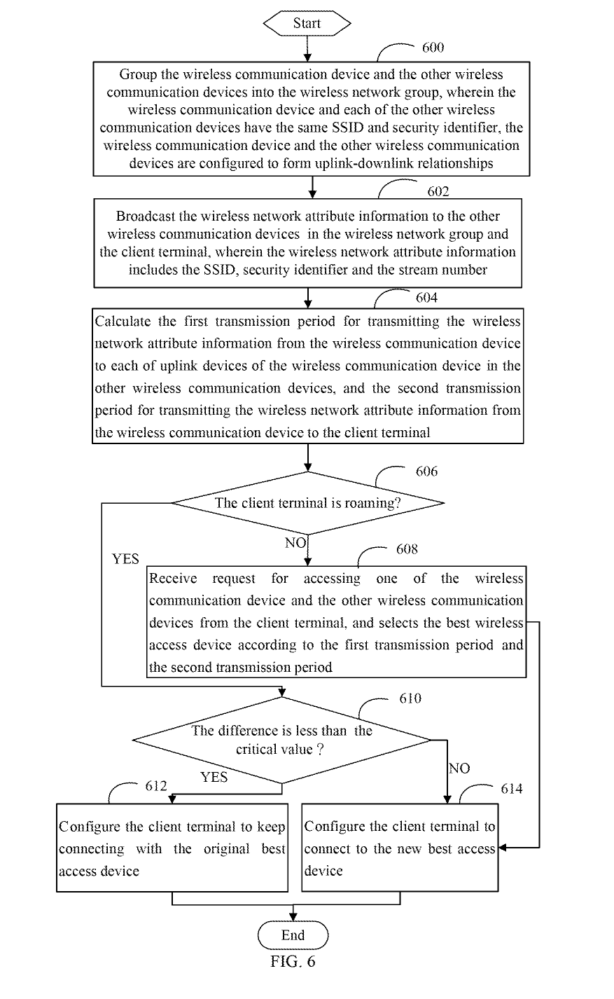

FIG. 6 shows an embodiment of a method for a wireless communication device 10a to select a best access device. The method is used in the wireless communication devices 10a-10d of FIG. 1, and is implemented by the blocks shown in FIG. 2 and FIG. 3. In the embodiment, the method is implemented by using the blocks of FIG. 2. In another embodiment, the method also can be realized by using the blocks of FIG. 3.

At block 600, the establishing module groups the wireless communication device and the other wireless communication devices into the wireless network group, wherein the wireless communication device and each of the other wireless communication devices have the same SSID and security identifier, the wireless communication device and the other wireless communication devices are configured to form uplink-downlink relationships.

At block 602, the broadcast module broadcasts the wireless network attributes information to the other wireless communication devices in the wireless network group and the client terminal, wherein the wireless network attributes information includes the SSID, security identifier and the stream number.

At block 604, the calculation module calculates the first transmission period for transmitting the wireless network attributes information from the wireless communication device to each of uplink devices of the wireless communication device in the other wireless communication devices, and the second transmission period for transmitting the wireless network attributes information from the wireless communication device to the client terminal.

At block 606, the calculation module determines whether the client terminal is in roaming state, if roaming, execute the block 612, if not, execute the block 610.

At block 608, the selection module receives request for accessing one of the wireless communication device and the other wireless communication devices from the client terminal, and selects the best wireless access device according to the first transmission period and the second transmission period.

At block 610, when the selection module detects a second best access device, the calculation module monitors a detected RSSI value of the client terminal in the new best access device and a default RSSI value of the client device terminal in the original best access device, and calculates the difference between the default RSSI value and the detected RSSI value.

When the difference is less than a threshold value, execute the block 612.

When the difference is not less than a threshold value, execute the block 614.

At block 612, the selection module configures the client terminal to keep connecting with the original best access device.

At block 614, the selection module configures the client terminal to connect to the new best access device.

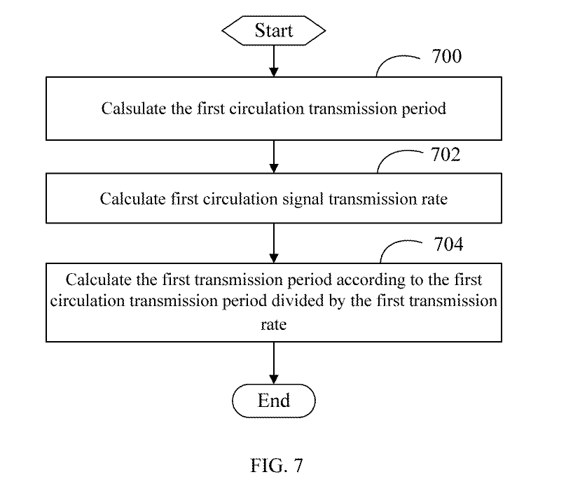

Referring to FIG. 7, FIG. 7 is the flowchart of an embodiment of the method for a wireless communication device to calculate the first transmission period. The method is used in the wireless communication device 10a of FIG. 1, and it is implemented by the blocks shown in FIG. 2 and FIG. 3. In the embodiment, the method is implemented by using the blocks of FIG. 2. In the statement, the method also can be realized by using the blocks of FIG. 3.

At block 700, the calculation module calculates the first circulation transmission period. Wherein the first circulation transmission period is the round-trip transmission period for transmitting the wireless network attributes information between the wireless communication device and each of uplink devices of the wireless communication device in the other wireless communication devices.

At block 702, the calculation module calculates the first circulation signal transmission rate. Wherein the first circulation signal transmission rate is a single signal transmission rate multiplied by the stream number, and the single signal transmission rate is a signal transmission rate that the wireless communication device transmits wireless network attributes information to one of the uplink devices of the wireless communication device in the other wireless communication devices.

At block 704, the first transmission period is calculated according to the first circulation transmission period divided by the first circulation signal transmission rate.

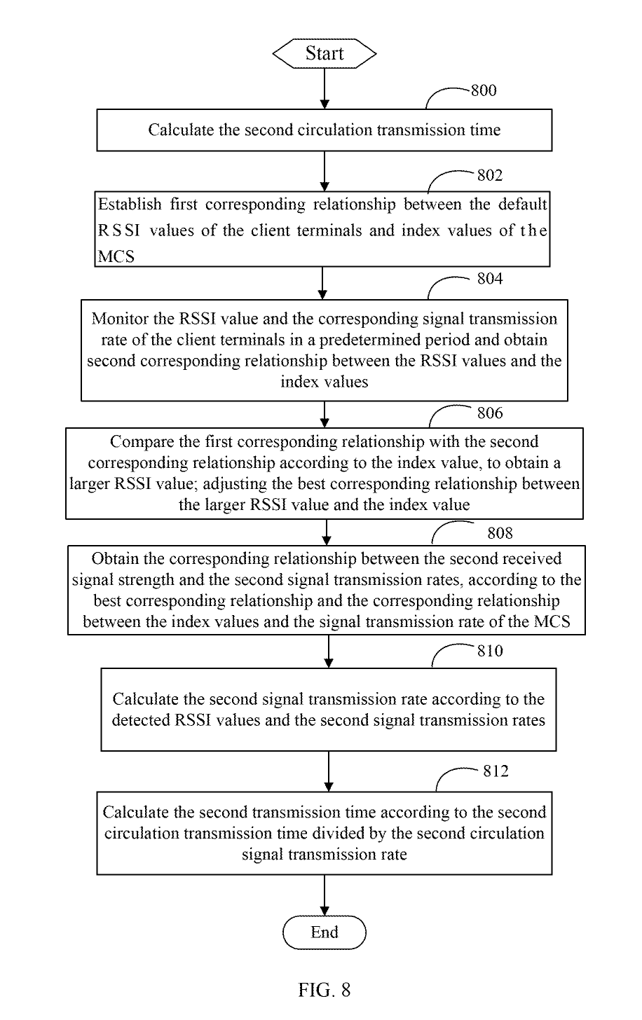

Referring to FIG. 8, it is the flowchart of an embodiment of the method for the wireless communication device to calculate the second transmission period in the present disclosure. The method is used in the wireless communication device 10a of FIG. 1, and it is implemented by the blocks shown in FIG. 2 and FIG. 3. In this embodiment, the method is implemented by using the blocks of FIG. 2. In another embodiment, the method also can be realized by using the block of FIG. 3.

At block 800, the calculation module calculates the second circulation transmission period. Wherein the second circulation transmission period is the round-trip transmission period for transmitting the wireless network attributes information between the wireless communication device and the client terminal.

At block 802, the preset sub module establishes first corresponding relationship between the default RSSI values of the client terminals and index values of a Modulation Coding Scheme (MCS).

At block 804, the monitoring sub module monitors the RSSI value and the corresponding signal transmission rate of the client terminals in a predetermined period after the client terminal connects to the wireless communication device, and obtains a plurality of values of signal transmission rate in the condition of a single RSSI value, and calculates the average value of the plurality of values of signal transmission rates, and finds out an index value in the MCS corresponding to the average value, to obtain second corresponding relationship between the RSSI values and the index values.

At block 806, the comparison sub module compares the first corresponding relationship with the second corresponding relationship according to the index value, to obtain a larger RSSI value, and adjusts the best corresponding relationship between the larger RSSI value and the index value.

At block 808, the matching sub module obtains the corresponding relationship between the detected RSSI values and the second signal transmission rates, according to the best corresponding relationship and the corresponding relationship between the index values and the signal transmission rates of the MCS.

At block 810, the selection sub module calculates the second signal transmission rate according to the corresponding relationship between the detected RSSI values and the second signal transmission rates.

At block 812, the calculation module calculates the second transmission period according to the second circulation transmission period divided by the second circulation signal transmission rate.

Through the embodiments, the present disclosure discloses wireless communication devices and methods for selecting the best access device, and it can group the wireless communication devices which have the same SSID and the security identifier into a wireless network, establish the NGMP in the wireless network group to make the wireless communication devices monitor the access state of the client terminal and transmit information each other, and select the best access device according to the information transmission period and the RSSI value. Even if the client terminal is roaming, the client terminal can determine whether changing the best access device according to the RSSI value.

It should be emphasized that the above-described embodiments of the present disclosure, including any particular embodiments, are merely possible examples of implementations, set forth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

What is claimed is:

1. A wireless communication device communicating with other wireless communication devices and providing a wireless network service for a client terminal, the wireless communication device comprising:
at least one processor;
a non-transitory storage system coupled to the at least one processor and configured to store one or more programs configured to be executed by the at least one processor, the one or more programs comprise instructions for:
grouping the wireless communication device and the other wireless communication devices into a wireless network group, wherein the wireless communication device and each of the other wireless communication devices have the same service set identifier (SSID) and security identifier, the wireless communication device and the other wireless communication devices are configured to form uplink-downlink relationships;
broadcasting wireless network attributes information to the other wireless communication devices in the wireless network group and the client terminal;
calculating a first transmission period for transmitting the wireless network attributes information from the wireless communication device to each of uplink devices of the wireless communication device in the other wireless communication devices, and a second transmission period for transmitting the wireless network attributes information from the wireless communication device to the client terminal;
receiving request to access one of the wireless communication device and the other wireless communication devices from the client terminal;
selecting one of the wireless communication devices and the other wireless communication devices as a access device according to the first transmission period and the second transmission period, in response to the request of the client terminal.

2. The wireless communication device as claimed in claim 1, wherein the access device is selected according to a minimum value of sum of the first transmission period and the second transmission period.

3. The wireless communication device as claimed in claim 2, wherein the wireless network attributes information comprises the SSID, the security identifier and stream number.

4. The wireless communication device as claimed in claim 3, wherein the first transmission period is calculated according to first circulation transmission period and first circulation signal transmission rate, and the first transmission period equals to the first circulation transmission period divided by the first circulation signal transmission rate.

5. The wireless communication device as claimed in claim 4, wherein the first circulation transmission period is a round-trip transmission period for transmitting the wireless network attributes information between the wireless communication device and one of the uplink devices of the wireless communication device in the other wireless communication devices, the first circulation signal transmission rate is a single signal transmission rate multiplied by the stream number, and the single signal transmission rate is a signal transmission rate that the wireless communication device transmits wireless network attributes information to one of the uplink devices of the wireless communication device in the other wireless communication devices.

6. The wireless communication device as claimed in claim 3, wherein the second transmission period is calculated according to second circulation transmission period and second circulation signal transmission rate, and the second transmission period equals to the second circulation transmission period divided by a second circulation signal transmission rate.

7. The wireless communication device as claimed in claim 6, wherein the second circulation transmission period is a round-trip transmission period for transmitting the wireless network attributes information between the wireless communication device and the client terminal.

8. The wireless communication device as claimed in claim 6, wherein the second signal transmission rate is obtained according to a relationship between the detected received signal strength indication (RSSI) value and the second signal transmission rate.

9. The wireless communication device as claimed in claim 8, wherein the one or more programs further comprise instructions for:
establishing a first corresponding relationship between default RSSI values of the client terminal and index values of a Modulation Coding Scheme (MCS);
monitoring a RSSI value and the corresponding signal transmission rate of the client terminals in a predetermined period after the client terminal connects to the wireless communication device;
obtaining a plurality of values of signal transmission rate in the condition of a single RSSI value;
calculating an average value of the plurality of values of signal transmission rates;
finding out an index value in the MCS corresponding to the average value, to obtain second corresponding relationship between the RSSI values and the index values;
comparing the first corresponding relationship with the second corresponding relationship according to the index value, to obtain a larger RSSI value;
adjusting the corresponding relationship between the larger RSSI value and the index value; and
obtaining the corresponding relationship between the detected RSSI values and the second signal transmission rates, according to the corresponding relationship and the corresponding relationship between the index values and the signal transmission rates of the MCS.

10. The wireless communication device as claimed in claim 2, when the client terminal is roaming and monitors a new access device in the wireless network group, the one or more programs further comprise instructions for:
monitoring a detected RSSI value of the client terminal in the new access device and a default RSSI value of the client device terminal in the original access device; and
calculating difference between the default RSSI value and detected RSSI value.

11. The wireless communication device as claimed in claim 10, wherein the original access device maintains a connection with the client terminal 30 when the difference is less than a threshold value.

12. The wireless communication device as claimed in claim 10, wherein the new access device is connected when the difference is not less than the threshold value.

13. A wireless communication device and method for choosing an access device, the wireless communication device communicating with the other wireless communication devices to provide wireless network service for the client terminal, the method comprising:
at least one processor;
a non-transitory storage system coupled to the at least one processor and configured to store one or more programs configured to be executed by the at least one processor, the one or more programs including instructions for:
grouping the wireless communication device and the other wireless communication devices into a wireless network group, wherein the wireless communication device and each of the other wireless communication devices have the same service set identifier (SSID) and security identifier, the wireless communication device and the other wireless communication devices are configured to form uplink-downlink relationships;
broadcasting wireless network attributes information to the other wireless communication devices and the client terminals in the wireless network group and the client terminal;
calculating a first transmission period for transmitting the wireless network attributes information from the wireless communication device to each of uplink devices of the wireless communication in the other wireless communication devices, and a second transmission period for transmitting the wireless network attributes information from the wireless communication device to the client terminal;
receiving request to access one of the wireless communication device and the other wireless communication devices from the client terminal;
selecting one of the wireless communication devices and the other wireless communication devices as a access device according to the first transmission period and the second transmission period, in response to the request of the client terminal.

14. The method for the wireless communication device choosing the access device as claimed in claim 13, the method also comprising:
selecting the access device according to a minimum value of sum of the first transmission period and the second transmission period.

15. The method for the wireless communication device choosing the access device as claimed in claim 14, wherein the wireless network attributes information comprises the SSID, the security identifier and the stream number.

16. The method for the wireless communication device choosing the access device as claimed in claim 15, the method of calculating the first transmission period comprising:
the first transmission period is calculated according to first circulation transmission period and first circulation signal transmission rate, and the first transmission period equals to the first circulation transmission period divided by the first circulation signal transmission rate.

17. The method of the wireless communication device for choosing the access device as claimed in claim 16, the method comprising:
the first circulation transmission period is the round-trip transmission period for transmitting the wireless network attributes information between the wireless communication device and one of the uplink devices of the wireless communication device in the other wireless communication devices, the first circulation signal transmission rate is a single signal transmission rate multiplied by the stream number, and the single signal transmission rate is a signal transmission rate that the wireless communication device transmits wireless network attributes information to one of the uplink devices of the wireless communication device in the other wireless communication devices.

18. The method of the wireless communication device for choosing the access device as claimed in claim 14, the method of calculating the second transmission period comprising:
the second transmission period is calculated according to second circulation transmission period and second circulation signal transmission rate, and the second transmission period equals to the second circulation transmission period divided by the second circulation signal transmission rate.

19. The method of the wireless communication device for choosing the access device as claimed in claim 18, wherein the second circulation transmission period is the round-trip transmission period for transmitting the wireless network attributes information between the wireless communication device and the client terminal.

20. The method of the wireless communication device for choosing the access device as claimed in claim 19, wherein a detected received signal strength indication (RSSI) value of the client terminal is monitored and a second signal transmission rate is calculated according to the corresponding relationship between the detected RSSI value and the second signal transmission rate.

21. The method of the wireless communication device for choosing the access device as claimed in claim 20, the method of matching the corresponding relationship of the detected RSSI value and the second signal transmission rate comprising:
establishing a first corresponding relationship between the default RSSI values of the client terminal and index values of a Modulation Coding Scheme (MCS);
monitoring a RSSI value and the corresponding signal transmission rate of the client terminals in a predetermined period after the client terminal connects to the wireless communication device; obtaining a plurality of values of signal transmission rate in the condition of a single RSSI value, calculating an average value of the plurality of values of signal transmission rates, finding out an index value in the MCS corresponding to the average value, to obtain second corresponding relationship between the RSSI values and the index value;
comparing the first corresponding relationship with the second corresponding relationship according to the index value, to obtain a larger RSSI value, and adjusts the corresponding relationship between the larger RSSI value and the index value;
obtaining the corresponding relationship between the detected RSSI values and the second signal transmission rates, according to the corresponding relationship and the corresponding relationship between the index values and the signal transmission rates of the MCS.

22. The method of the wireless communication device for choosing the access device as claimed in claim 14, when the client terminal is roaming and monitors a new access device in the wireless network group, the one or more programs further include instructions for:
monitoring a detected RSSI value of the client terminal in the new access device and a default RSSI value of the client device terminal in the original access device; and
calculating the difference between the default RSSI value of second RSSI value.

23. The method of the wireless communication device for choosing the access device as claimed in claim 22, wherein the original access device maintains a connection with the client terminal 30 when the difference is less than a threshold value.

24. The method of the wireless communication device for choosing the access device as claimed in claim 22, wherein the new access device is connected when the difference is not less than the threshold value.
